(19) United States
(12) Patent Application Publication
(10) Pub. No.: US 2025/0384161 A1
(43) Pub. Date: Dec. 18, 2025

(54) SECURE QUANTILE BUCKETING OF PRIVATE DATA

(71) Applicants: Beijing Zitiao Network Technology Co., Ltd., Beijing (CN); Lemon Inc., Grand Cayman (KY)

(72) Inventors: Chuyuan Chen, Beijing (CN); Dong Yin, Beijing (CN); Wei Dai, Culver City, CA (US); Donghang Lu, Culver City, CA (US); Qiang Yan, Beijing (CN); Li Wang, Beijing (CN)

(21) Appl. No.: 18/958,914

(22) Filed: Nov. 25, 2024

Related U.S. Application Data
(63) Continuation of application No. PCT/CN2024/099291, filed on Jun. 14, 2024.

(51) Int. Cl. G06F 21/62

(52) U.S. Cl. CPC G06F 21/6254

(57) ABSTRACT

Methods, systems, and apparatus, including computer programs encoded on computer storage media, for performing secure quantile bucketing. One of the methods includes for a first party and a second party, performing secure quantile bucketing on a joint dataset comprising first data of the first party and second data of the second party, the performing comprising: precomputing a secret shared count lookup table for the joint dataset; determine secret shares of bucket thresholds for each bucket interval; assign data points to the buckets based on the secret shared bucket thresholds; and provide the first party and the second party with an output comprising a list of bucket thresholds in secret shared form and an label per data point in secret shared form identifying the bucket assigned to each data point.

### CLAIM OF PRIORITY

This application claims priority to International Patent Application No. PCT/CN2024/099291 filed Jun. 14, 2024, the entire contents of which are hereby incorporated by reference.

### BACKGROUND

This specification relates to data security and in particular to securely performing operations on joint data without revealing the data of either party to the other party. Many parties, e.g., online service providers, collect data including user data, for example, when creating user accounts, or based on user interactions with the online service providers. In some scenarios, parties may wish to collaborate using joint data. For example, to perform data analytics or other data computations. However, to maintain data security as well as privacy associated with the data, neither party wishes to share their private data with the other party.

### SUMMARY

This specification describes techniques for performing quantile bucketing on joint data between parties in a secure and privacy-preserving manner. Data is precomputed to reduce the communicative complexity of later operations to calculate the bucket thresholds for quantile bucketing. The final bucketing is performed, and secret shares of the label associated with each datapoint of the joint dataset are generated.

In general, one innovative aspect of the subject matter described in this specification can be embodied in methods that include the actions of, for a first party and a second party, performing secure quantile bucketing on a joint dataset comprising first data of the first party and second data of the second party, the performing comprising: precomputing a secret shared count lookup table for the joint dataset; determine secret shares of bucket thresholds for each bucket interval; assign data points to the buckets based on the secret shared bucket thresholds; and provide the first party and the second party with an output comprising a list of bucket thresholds in secret shared form and an label per data point in secret shared form identifying the bucket assigned to each data point. Other embodiments of this aspect include corresponding computer systems, apparatus, and computer programs recorded on one or more computer storage devices, each configured to perform the actions of the methods.

This specification uses the term “configured” in connection with systems, apparatus, and computer program components. For a system of one or more computers to be configured to perform particular operations or actions means that the system has installed on it software, firmware, hardware, or a combination of them that in operation cause the system to perform the operations or actions. For one or more computer programs to be configured to perform particular operations or actions means that the one or more programs include instructions that, when executed by data processing apparatus, cause the apparatus to perform the operations or actions. For special-purpose logic circuitry to be configured to perform particular operations or actions means that the circuitry has electronic logic that performs the operations or actions.

The subject matter described in this specification can be implemented in particular embodiments so as to realize one or more of the following advantages.

The disclosed techniques do not require communicatively intensive sorting of secret share values as in prior techniques. Communication complexity can refer to the amount of communication required to execute a process that is distributed amongst two or more parties. Specifically, communicative complexity in prior techniques often grows on the order of n log n, where n is the size of the dataset. Using the described techniques, the complexity instead grows linearly such that, for example, if the dataset is 10× larger the communicative complexity grows by 10× and not more. Similarly, by eliminating sorting, the described subject matter further eliminates duplication issues that are prevalent when sorting. Moreover, when a dataset is updated, the described techniques only need to attend to the updated entries (i.e., inserted and removed entries). Consequently, this has communicative complexity that is linear to the size of the update. By contrast, prior techniques require the entire updated dataset to be sorted once again.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example system for performing secure quantile bucketing.

FIG. 2 is a flow diagram of an example process for secure quantile bucketing.

FIG. 3 is a flow diagram of an example process for generating secret shares of bucket indexes for data in a joint dataset.

FIG. 4 illustrates a schematic diagram of an example computing system.

Like reference numbers and designations in the various drawings indicate like elements.

### DETAILED DESCRIPTION

Bucketing, also referred to as binning, is a process that transforms numerical values of individual data items (or data points) into categorical values using a set of thresholds. Bucketing is often used to perform various statistical analytics or for machine learning applications. One typical example of bucketing is to assign data points to categories that each have predefined intervals, for example, equal-sized intervals or fixed range intervals. For example, a collection of temperature records can be divided into four buckets: 0-10 degrees Celsius, 11-20 degrees Celsius, 21-30 degrees Celsius, and 30 degrees Celsius and above. In such a bucketing scenario, the number of data points in each category can vary depending on the distribution of temperature records in the collection of data.

Another form of bucketing is referred to as quantile bucketing. In quantile bucketing the thresholds of the categories are chosen so that each bucket contains substantially the same number of data points. In other words, the aim is to equally fill, to the extent possible, each bucket and the category thresholds are selected to generate that outcome. For example, if a dataset includes 5000 data values and there are 10 buckets, the thresholds are set so that each bucket contains approximately 500 data values. Thus, for example, if the above reference temperature records are skewed so that the majority of individual temperature data points are between 21-30 degrees Celsius, there may be several buckets in that range and fewer buckets covering other temperature ranges.

When the data values are all known, bucketing is a straightforward process. However, bucketing in a privacy-preserving manner is more difficult. For example, two parties, each having their own distinct dataset, may wish to perform bucketing on the joint data of the parties. However, each party may not wish to share the data values of their datasets. In such scenarios, secret sharing can be used so that neither party alone learns the true data. Secret sharing is a cryptographic method to enhance the security of online communications by dividing a “secret”, e.g., a dataset, into multiple parts. Each part is then distributed to one of the parties involved, and the original secret can only be reconstructed when a sufficient number of these parts are combined.

One solution is to have a trusted third party access the joint data and perform the bucketing. However, having two distrusting parties agree on a fully trusted third party may be impractical. A second solution is to only operate on individual data. For example, each party performs the bucketing over their respective datasets using equal width bucketing. Information about the buckets could then be shared with the other party, e.g., a count of data points within each bucket. However, this has more limited usability and does not support quantile bucketing. A third solution uses secure multiparty computation, which includes a particular class of cryptographic techniques, that can perform bucketing blindly on data without revealing any true values of data points or bucket indexes. Each of these solutions can provide strong privacy protection while assuming little trust, however, they can also suffer from high computational costs and communicative overhead. They may also be difficult to scale to larger datasets.

This specification describes techniques for quantile bucketing that provide increased efficiency and lower communicative costs while being highly scalable. In particular, data is precomputed to reduce the communicative complexity of later operations to calculate the bucket thresholds for quantile bucketing. The final bucketing is performed, and secret shares of the label associated with each datapoint of the joint dataset are generated.

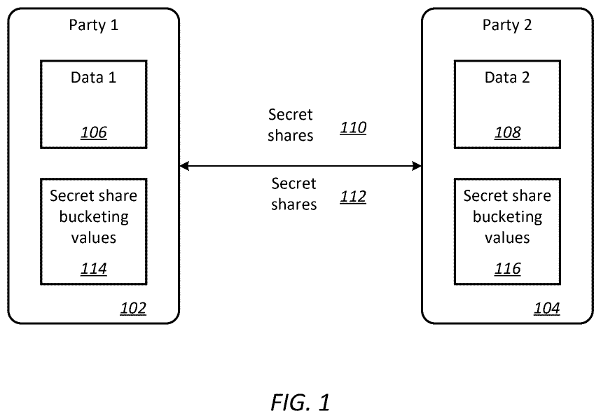

FIG. 1 is a block diagram of an example system 100 for performing secure quantile bucketing. System 100 includes a party P1 (102) and a party P2 (104). Party P1 (102) includes a private dataset D1 (106) and party P2 (104) includes a private dataset D2 (108). Party P1 and party P2 may wish to perform quantile bucketing on their joint data without revealing their respective private datasets to the other party. Furthermore, they may not want to reveal the actual bucketing indices (e.g., the range of values for each bucket) as this can leak private information about the makeup of the values of the private datasets.

Party P1 (102) provides a secret share 110 of dataset D1 (106) to party P2 (104). Party P2 (104) provides a secret share 112 of dataset D2 (108) to party P1 (102). Following secure data processing protocols described below, Party P1 (102) determines secret shares of the bucket indexes 114 for the data values in D1 (106) based on the joint set of data. Similarly, party P2 (104) determines secret shares of the bucket indexes 116 of for the data values in D2 (104) based on the joint set of data. Thus, a party can perform some analytics on the joint data without obtaining the dataset from the other party or knowing the actual bucket ranges.

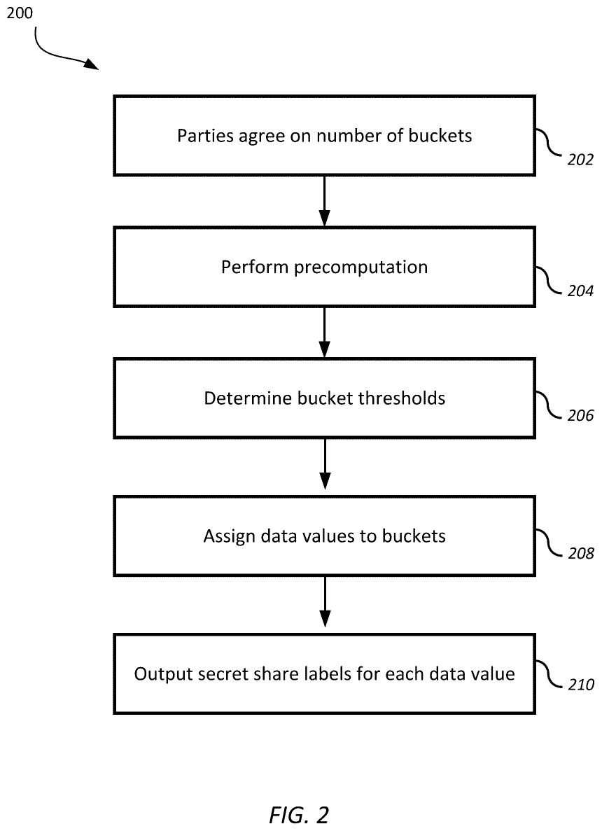

FIG. 2 is a flow diagram of an example process 200 for secure quantile bucketing. For convenience, the process 200 will be described as being performed by a system of one or more computers, located in one or more locations, and programmed appropriately in accordance with this specification. For example, the system may include joint operations carried out by the individual parties to operations performed on their joint data, e.g., quantile bucketing of the joint data. Each party may each include one or more computing devices or servers that are in communication with the other party.

The system specifies bucketing parameters (202). In particular, the number of buckets is predetermined. The parties can confer and determine the granularity of the bucketing e.g., 10 buckets vs. 100 buckets. The parties may decide according to various factors including, for example, the size of the datasets or the value space of the datasets (i.e., the range of values within the dataset).

The system performs precomputation on the joint dataset (204). The precomputation is used to generate some data for later use when determining bucket thresholds. The precomputation results in secret shares of a combined count lookup table that corresponds to the full joint dataset. The precomputation has a complexity linear to the size of the dataset.

The system determines quantile bucket thresholds (206). The system uses the precomputation results (the count lookup table) to determine the bucket thresholds defining the ranges for each bucket. Rather than the true range values, the system determines the secret shares of the bucket ranges. Because of the precomputation, this determination step is less communicatively costly.

The system assigns the secret share values to the buckets based on the determined secret share thresholds (208). Once the secret shares of the ranges for each bucket are identified, the system can perform secure comparisons over secret shares to determine which bucket each data value in the joint dataset belongs. There are various techniques for performing secure comparisons that involve comparison of two or more secret values in a privacy-preserving manner.

Based on the secret share comparison of a given secret share data value, a determination of whether the data value falls within the range of the first bucket. If so, it is added to the bucket. If not, it is reserved for future bucketing in subsequent iterations. Each bucket is sequentially filled using the secure comparisons. Throughout the computation, only secret shares are used, so no private raw information is revealed. The bucketing can be performed without first sorting the data values (or their secret shares).

The system generates, at each party, the secret shares of the bucket indexes of all of the joint data (210). The system uses the assigned bucketing of step 208 to determine the secret share bucket index for each secret share of data within the joint dataset. Each individual party can then use the bucketing information to gain insights into the joint dataset without knowing either the values of the other party's data or the ranges of the buckets. Instead they know the number of buckets.

The outcome of the proposed techniques for performing quantile bucketing provide a list of bucket thresholds in secret shared form and an index/label per data point in secret shared form indicating the bucket it is assigned to. Although either party only sees its own secret shares, they can run statistical analysis or machine learning training and inference on secret shared values. For example, training gradient-boosted trees performs bucketing and uses bucket indexes rather than original data values. The proposed quantile bucketing techniques do not result in revealable insights but rather enable further privacy-preserving data processing.

The steps above will now be described in greater detail with respect to each party operating on secret share information received from the other party. Both parties should end up with the same resulting secret shares of the buckets.

An overall model for performing the bucketing can be based on two parties, P₁ and P₂ who wish to perform quantile bucketing on their joint dataset D. The values of the data in D also have a data space [symbol] where | [symbol] |=m. The data space represents the range of values within the joint dataset. For example, if the joint dataset has a size n representing the total number of members, e.g., 1000, but each value has a range of integer values from 1-100, then the data space is 100. The data space can be further defined. For example, if the joint dataset represents units of a product, the granularity of interest may only be at 100 unit increments. Thus, the data space counts each 100, not, for example, each individual unit. For example, if the data values in the database have integer values ranging from 100 to 10,000, the data space can be 100 rather than 10,000. In some implementations, preprocessing is performed on the dataset of each party to, for example, round the values based on the desired dataspace, e.g., rounding all data values to the nearest 100.

In some implementations, the data space is assumed to be discrete and all data within the dataset can be represented in log m bits. This assumption can be reasonable since numerical values stored on a computer are discrete and are represented by a limited number of bits. In some implementations, the values are fixed-point values, but they could be floating-point values. Using floating-point values extends the dynamic range of fixed-point representations, but does not increase the data space capacity.

The joint dataset D is split between P₁ and P₂. The splitting can be by partitioning, secret sharing, or a combination. In some implementations, the joint dataset D is split into three disjoint datasets, D₁, D₂, and D_{*} such that D=D₁+D₂+D_{*}. D₁ is local to P₁ and D₂ is local to P₂. Dx, however, is local to neither. Instead, D_{*} is split into secret shares separately held by P₁ and P₂. Thus, [symbol] D [symbol] ₁ is local to P₁ and [symbol] D_{*} [symbol] ₂ is local to P₂ where the combination provides D_{*}. When using XOR based secret sharing D_{*}[i]= [symbol] D_{*} [symbol] ₁[i]⊕ [symbol] D_{*} [symbol] ₂[i], for all i=1, 2, . . . , n_{*}. In this specification, the use of double brackets [symbol] * [symbol] indicates a secret share form.

Additionally, an indicator function δ can be defined. The indicator function δ: [symbol] × [symbol] [symbol] {0,1} such that δ (x, y)+δ(x, y)=1 for all x≠y∈ [symbol] and δ(x, x)=0. For example, the numerical comparison function < is an indicator function.

Techniques are provided in this specification that allow for performing quantile bucketing without directly sorting the joint data and with reduced communication complexity as compared to prior methods. Additionally, the provided techniques allow for a dataset D to be partitioned into buckets of almost equal size B₁, B₂, . . . , Bₖ so that δ(x, y)=1 for all x∈Bᵢ and y∈Bⱼ for all i<j∈{1, 2, . . . , k}. For all data points d∈D, the system assigns a label l if d∈Bₗ.

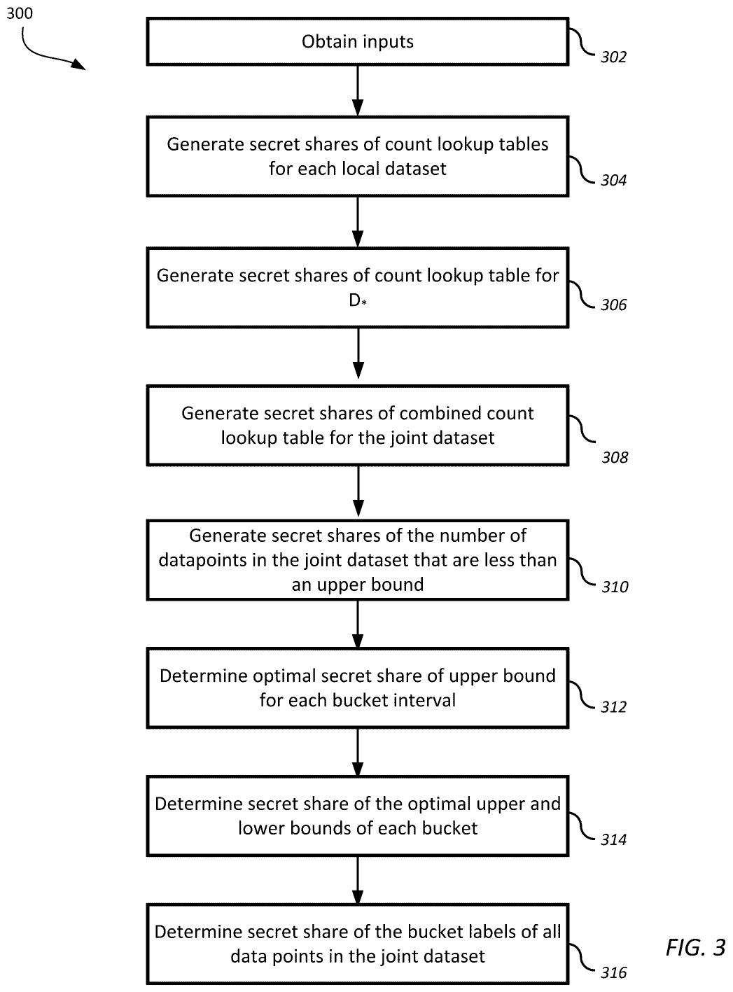

FIG. 3 is a flow diagram of an example process 300 for generating secret shares of bucket indexes for data in a joint dataset. For convenience, the process 300 will be described as being performed by a system of one or more computers, located in one or more locations, and programmed appropriately in accordance with this specification. For example, the system may include joint operations carried out by the individual parties to operations performed on their joint data, e.g., quantile bucketing of the joint data. Each party may each include one or more computing devices or servers that are in communication with the other party.

The system obtains inputs (302). The inputs include the number of buckets, k determined, for example, by the parties. Additionally, the first party P₁ inputs D₁ and [symbol] D_{*} [symbol] ₁. The second party P₂ inputs D₂ and [symbol] D_{*} [symbol] ₂.

The system generates secret shares of a count lookup table for each local dataset Dᵢ (304). Specifically, a protocol [symbol] Tᵢ [symbol] ←localcount (Dᵢ) returns the secret shares of the count lookup table corresponding to Dᵢ and is performed locally by Pion dataset Dᵢ. Thus, each party P₁ and P₂ constructs respective tables from local data Dᵢ and D₂. P₁ constructs respective tables [symbol] Tᵢ [symbol] ₁ and [symbol] Tᵢ [symbol] ₂ each with m rows. For each jϵ [symbol] , Pᵢ counts the number of data points in Dᵢ that are less than j as s, generates secrets shares [symbol] s [symbol] , inserts j and [symbol] s [symbol] ₁ into the next row of [symbol] Tᵢ [symbol] ₁ and inserts j and [symbol] s [symbol] ₂ into the next row of [symbol] Tᵢ [symbol] ₂. Finally, each party sends their respective secret share of the count lookup table to the other party, i.e., Pᵢ sends [symbol] Tᵢ [symbol] ₃₋ᵢ to P₃₋ᵢ.

Table 1 illustrates the input and output from the localcount protocol:

TABLE 1

| Component | Symbol | Description |
|---|---|---|
| Private Input | Dᵢ | The local dataset of Dᵢ |
| Private output | [symbol] Tᵢ [symbol] | The secret shares of the count lookup |
| | | table corresponding to Dᵢ |

The localcount protocol runs locally on each party P₁ and separately on datasets D₁ and D₂ with negligible overhead. The resulting precomputation provides two secret shared tables [symbol] T₁ [symbol] and [symbol] T₂ [symbol] each with size m.

The system generates secret shares of the count lookup table corresponding to D* (306). As noted above, the joint dataset D can be divided into disjoint datasets, D₁, D₂, and DR. This step provides a securecount protocol that outputs the secret shares of a count lookup table corresponding to Dx.

The protocol [symbol] T_{*} [symbol] <securecount (D_{*}) returns the secret shares of the count lookup table corresponding to D_{*} and is performed interactively by P₁ and P₂ on secret shared dataset D_{*} in a similar manner as the localcount protocol.

Table 2 illustrates the input and output from the securecount protocol:

TABLE 2

| Component | Symbol | Description |
|---|---|---|
| Private Input | [symbol] D_{*} [symbol] | The secret shared datasets of P₁ and P₂ |
| Private output | [symbol] T_{*} [symbol] | The secret shares of the count lookup |
| | | table corresponding to D_{*} |

One technique for implementing the protocol is to call a secure comparison protocol that takes secret shares of inputs and produces secret shares of the comparison result. This results in complexity O(n·m·log m) The resulting precomputation provides secret shared table [symbol] T_{*} [symbol] with size m. Of note is that the complexity scales quasilinearly on data space m rather than the size of the datasets n, in contrast to prior techniques. This lowers the communication complexity significantly for large datasets.

The system generates secret shares of a combined count lookup table for the joint dataset D (308). A protocol [symbol] T [symbol] ←prebucket (D₁, D₂, [symbol] D_{*} [symbol] ) forms a combined secret share count lookup table corresponding to D where [symbol] T [symbol] ᵢ[j]= [symbol] T₁ [symbol] ᵢ[j]+ [symbol] T₂ [symbol] ᵢ[j]+ [symbol] T [symbol] ᵢ[j]. The prebucket protocol calls the localcount protocol twice (for P₁ and P₂) and the securecount protocol once and is also considered precomputation for the quantile bucketing.

The system generates secret shares of the number of datapoints in the joint dataset that are less than an upper bound v (310).

The protocol [symbol] T[v] [symbol] ←count ( [symbol] v [symbol] , [symbol] T [symbol] ) returns the secret shares of the number of data points in D that are less than v. The protocol relies on the precomputed secret shared lookup table [symbol] T [symbol] that has size m. The keys to T are all values of [symbol] ; the values are the number of data points in D that are less than the corresponding key.

The protocol can be constructed with two symmetric executions of a single-server private information retrieval (PIR) protocol or a 1-m oblivious transfer (OT) protocol. A PIR protocol is a cryptographic technique that allows a party to retrieve an item of information from a database held on another party, e.g., the single server, without revealing which item of information is received. An OT protocol is a cryptographic technique in which an actor transfers one of many pieces of information to a receiver but remains oblivious as to what piece of information has been sent. OT can be considered a symmetric version of PIR where the privacy of the database is also required.

P₁ offsets table [symbol] T [symbol] ₁ by [symbol] v [symbol] ₁ rows to get a new table π [symbol] ᵥ [symbol] _{₁}. P₁ generates a random share r and masks all values in the new table. P₁ responds to P₂'s private query [symbol] v [symbol] ₂ using the new offset and masked table and a PIR protocol. Next, P₂ obtains π [symbol] ᵥ [symbol] _{₁}( [symbol] T [symbol] ₁)[ [symbol] v [symbol] ₂]= [symbol] T [symbol] ₁[v]⊕r, and P₁ keeps r so that they each hold secret shares of [symbol] T [symbol] ₁[v]. The two parties repeat the process in reversed roles and obtain secret shares of [symbol] T [symbol] ₂[v]. Adding the two secret shares, they both have secret shares of T[v].

Table 3 illustrates the input and output from the count protocol:

TABLE 3

| Component | Symbol | Description |
|---|---|---|
| Private Input | [symbol] ν [symbol] | The secret shares of an upper |
| | | bound ν |
| Private Output | [symbol] T[ν] [symbol] | The secret shares of the number of |
| | | data points in D that are less than ν |
| Precomputation | [symbol] T [symbol] | The secret shares of the count lookup |
| | | table corresponding to D |
| Subprotocol | Single-server PIR | |
| | or 1-m OT | |

The choice of whether to use the single-server PIR protocol or the 1-m OT protocol can be flexible or implementation dependent. In some instances, a single-server PIR protocol can be selected with communicative complexity O(m^{0.5}). The count protocol makes two parallel calls to the single-server PIR protocol and has complexity O(m^{0.5}).

The system determines an optimal secret share of the upper bound (312). In particular, a protocol [symbol] v [symbol] ←search (acc, [symbol] T [symbol] ) recursively searches, e.g., as a binary search algorithm, for an optimal upper bound v in all less than m possible values such that the number of data points in D that are less than v is close to acc and returns secret shares of v. In other words, in the search protocol v means that among all the possible values of v, a specific v is determined whose count is acc. Acc refers to an accumulated bucket size, i.e., the total number of data points in each bucket given quantile bucketing and k buckets. The aim of the search protocol is to identify the upper boundary value of each bucket so that the desired membership of each bucket is achieved.

The meaning of “close” can be defined by a specified error margin of e. The realization of the search protocol uses count ( ) as the building block. Table 4 illustrates the components of the search protocol.

TABLE 4

| Component | Symbol | Description |
|---|---|---|
| Public Input | acc | The desired accumulated bucket |
| | | size |
| Private Output | [symbol] ν [symbol] | The secret shares of the desired |
| | | upper bound of the interval |
| Precomputation | [symbol] T [symbol] | The secret shares of the count |
| | | lookup table corresponding to D |
| Subprotocol | [symbol] s [symbol] ←count( [symbol] ν [symbol] , | Returns the secret shares of the |
| | [symbol] T [symbol] ) | number of data points in D that |
| | | are less than ν |

If the secret shares of a tighter search space of v are known, for example, [vₘᵢₙ, vₘₐₓ], the recursive search protocol can be improved and terminated with fewer recursions. The improved protocol can be denoted as: [symbol] v [symbol] ←search (acc, [symbol] T [symbol] , [symbol] vₘᵢₙ [symbol] , [symbol] vₘₐₓ [symbol] )

The search protocol makes log m+1 sequential calls to the count protocol and has complexity O(m^{0.5} log m). By default, vₘᵢₙ and vₘₐₓ are the minimum and maximum values in the data space [symbol] . In specific cases, if it does not compromise security or privacy, two parties may jointly compute secret shares of vₘᵢₙ and vₘₐₓ.

The system determines secret shares of the optimal upper and lower bounds of each bucket (314). The protocol [symbol] v₁ [symbol] , [symbol] v₂ [symbol] , . . . , [symbol] vₖ₋₁ [symbol] ←getbuckets (k, n, [symbol] T [symbol] ) returns optimal upper and lower bounds of k buckets of (almost) equal sizes. The value of acc can be set to multiples of n/k. Optimal upper and lower bounds means the bounds for all of the k buckets are selected so that each bucket will be populated with close to the same number of data points from the dataset D. Table 5 illustrates the components of the getbuckets protocol.

TABLE 5

| Component | Symbol | Description |
|---|---|---|
| Public Input | k | The desired number of |
| | | buckets |
| | n | The number of data points |
| | | in D |
| Private Output | [symbol] ν₁ [symbol] , [symbol] ν₂ [symbol] , . . . , | The secret shares of the |
| | [symbol] νₖ₋₁ [symbol] | desired splitting bounds |
| | | of buckets |
| Precomputation | [symbol] T [symbol] | The secret shares of the |
| | | count lookup table |
| | | corresponding to D |
| Subprotocol | [symbol] ν [symbol] ← search | Returns secret shares of |
| | (acc, [symbol] T [symbol] , [symbol] νₘᵢₙ [symbol] , | an optimal upper bound ν |
| | [symbol] νₘₐₓ [symbol] ) | such that the number of data |
| | | points in D that are less |
| | | than ν is close to acc. |

The getbuckets can make m calls to the count protocol to handle all k buckets in one pass and has complexity O(m log m). However, this approach makes sequential calls to a secure comparison protocol and consequently has a large number of communication rounds.

Instead, the getbuckets protocol makes calls to the search protocol and has communicative complexity O(k m^{0.5} log m).

The system determines secret share of the bucket labels of all data points in the joint dataset (316). A protocol [symbol] B [symbol] <bucketing (D₁, D₂, [symbol] DE [symbol] , [symbol] v₁ [symbol] , [symbol] v₂ [symbol] , . . . , [symbol] vₖ₋₁ [symbol] ) returns the secret shares of the bucket labels of all data points in D. The bucketing protocol executes (n·k) secure comparisons to assign each of the data points to the buckets. Each data point is then associated with the secret shares of the corresponding bucked index. Table 6 illustrates components of the bucketing protocol.

TABLE 6

| Component | Symbol | Description |
|---|---|---|
| Private Input | D₁, D₂, [symbol] D_{*} [symbol] | The data of P₁ and P₂ |
| | [symbol] ν₁ [symbol] , [symbol] ν₂ [symbol] , . . . , | The secret shares of the desired |
| | [symbol] νₖ₋₁ [symbol] | splitting bounds of buckets |
| Private output | [symbol] B [symbol] | The secret shares of the bucket |
| | | indexes of all data in D |

The complexity of the bucketing protocol is O(n k log m). At the end of the bucketing protocol, each party, P₁, obtains [symbol] B [symbol] , allowing the parties to evaluate the quantile bucketed data without learning the real values of the bucketing boundaries or the data of the other party. For example, if a given datapoint is in bucket [symbol] Bₗ [symbol] , the datapoint is associated with secret shares of the label, i.e., [symbol] l [symbol] . Thus, for each data point d∈D, P₁ and P₂ obtain secret shares [symbol] l [symbol] ₁ and [symbol] l [symbol] ₂ of a label l∈{1, 2, . . . , k} indicating the bucket assigned to datapoint d.

Using the techniques described above, two parties can collaborate on joint data while maintaining data security and privacy. For example, the first party P₁ does not learn D₂ of party 2 or DR. Likewise, the second party P₂ does not learn D₁ or DR. Furthermore, neither P₁ nor P₂ learn the bucket labels. However, some information is not protected including k, n, n₁, n₂, and n_{*}.

Processing split or secret shared datasets has real-world demands. For example, some online service providers have developed technology that gathers secret shares of user telemetry and reveals only statistical results. Other online content platforms provide sponsored content generators, e.g., advertisers with the ability to perform attribution while keeping data secret shared on distributed servers. In this example, user data are secret shared on two servers to preserve privacy. Data split in silos is also common. For example, two financial institutions may want to run analysis on customers to detect money launderers, without sharing the customer data with each other.

Bucketing is a common preprocessing on training data in machine learning systems. One example is training a decision tree or a tree ensemble on a joint dataset. At a high level, a decision tree is a one-direction graph of nodes that each makes an inquiry to go left or right according to a threshold and finally reach one of the labels as output. Intuitively, training a decision tree does not require high-resolution information, but rather possible thresholds to choose from. For example, to predict the likelihood of a particular event, only certain ranges may be relevant. The underlying datapoints can be bucketized into ranges before training. And to ensure ranges with low population are not ignored by the training process, quantile bucketing is preferred over equal-width bucketing.

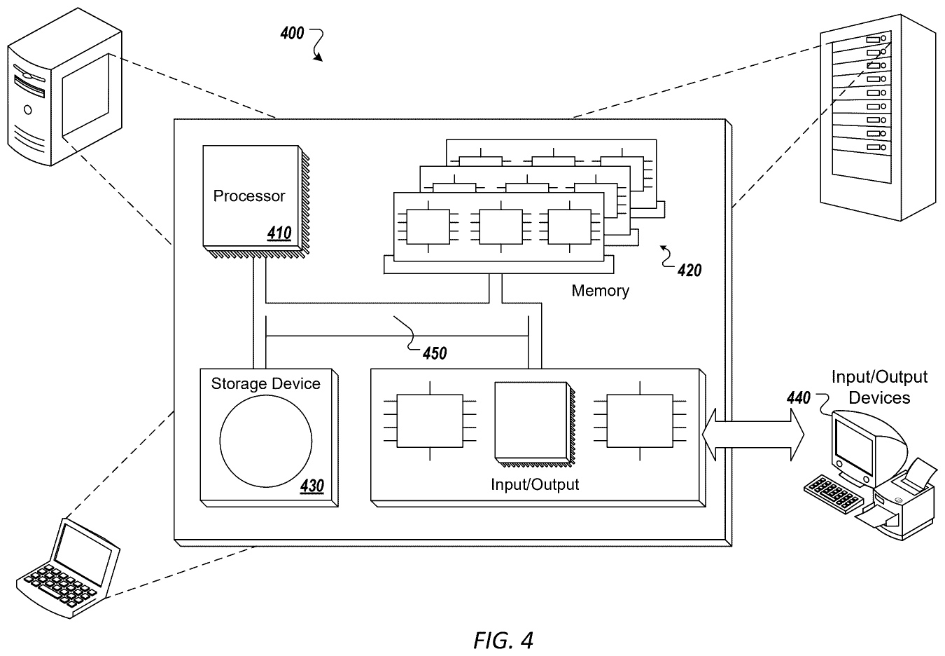

FIG. 4 illustrates a schematic diagram of an example computing system 400. The system 400 can be used for the operations described in association with the implementations described herein. For example, the system 400 may be included in computing devices of the one or more online components and/or the one or more offline components. The system 400 includes a processor 410, a memory 420, a storage device 430, and an input/output device 440. The components 410, 420, 430, and 440 are interconnected using a system bus 450. The processor 410 is capable of processing instructions for execution within the system 1000. In some implementations, the processor 410 is a single-threaded processor. The processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. The memory 420 can be a volatile memory unit or a non-volatile memory unit. The storage device 430 is capable of providing mass storage for the system 400. The storage device 430 is a computer-readable medium. The storage device 430 may be a floppy disk device, a hard disk device, an optical disk device, or a tape device. The input/output device 440 provides input/output operations for the system 400. The input/output device 440 includes a keyboard and/or pointing device. The input/output device 440 includes a display unit for displaying graphical user interfaces.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, an app, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface, a web browser, or an app through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the device, which acts as a client. Data generated at the user device, e.g., a result of the user interaction, can be received at the server from the device.

In addition to the embodiments of the attached claims and the embodiments described above, the following embodiments are also innovative:

Embodiment 1 is a method, the method comprising: for a first party and a second party, performing secure quantile bucketing on a joint dataset comprising first data of the first party and second data of the second party, the performing comprising: precomputing a secret shared count lookup table for the joint dataset; determining secret shares of bucket thresholds for each bucket interval; assigning data points to the buckets based on the secret shared bucket thresholds; and providing the first party and the second party with an output comprising a list of bucket thresholds in secret shared form and an label per data point in secret shared form identifying the bucket assigned to each data point.

Embodiment 2 is the method of embodiment 1, wherein precomputing the count lookup table for the joint dataset comprises: generating secret shares of a first count lookup table for the first data and a second count lookup table for the second data; generating secret shares of a count lookup table for a secret shared dataset; and combining the secret shares of the count lookup tables to generate secret shares of a combined count lookup table for the joint dataset.

Embodiment 3 is the method of any of embodiments 1 through 2, wherein determining the bucket thresholds for each bucket interval comprises: generating secret shares of a number of datapoints in the joint dataset that are less than an upper bound; determining a secret share of the upper bound; and determining a secret share of the upper and lower bounds of each bucket.

Embodiment 4 is the method of any of embodiments 1 through 3, wherein the generating the secret shares of the number of data points in the joint dataset that are less than an upper bound relies on the precomputation such that the communication complexity is independent of the size of the joint dataset.

Embodiment 5 is the method of any of embodiments 1 through 4, wherein assigning data points to the buckets comprises: performing secure comparisons to determine, for each datapoint, the corresponding bucket.

Embodiment 6 is the method of any of embodiments 1 through 5, wherein the number of buckets is predefined, and neither the private data of the respective other party nor the true values of the bucket intervals is revealed to either party.

Embodiment 7 is the method of any of embodiments 1 through 6, wherein the output is used to perform one or more of i) statistical analysis or ii) machine learning training and inference on secret shared values.

Embodiment 8 is a system comprising: one or more computers and one or more storage devices storing instructions that are operable, when executed by the one or more computers, to cause the one or more computers to perform the method of any one of embodiments 1 to 7.

Embodiment 9 is a computer storage medium encoded with a computer program, the program comprising instructions that are operable, when executed by data processing apparatus, to cause the data processing apparatus to perform the method of any one of embodiments 1 to 7.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

1. A method comprising:
for a first party and a second party, performing secure quantile bucketing on a joint dataset comprising first data of the first party and second data of the second party, the performing comprising:
precomputing a secret shared count lookup table for the joint dataset;
determining secret shares of bucket thresholds for each bucket interval;
assigning data points to the buckets based on the secret shared bucket thresholds; and
providing the first party and the second party with an output comprising a list of bucket thresholds in secret shared form and an label per data point in secret shared form identifying the bucket assigned to each data point.

2. The method of claim 1, wherein precomputing the count lookup table for the joint dataset comprises:
generating secret shares of a first count lookup table for the first data and a second count lookup table for the second data;
generating secret shares of a count lookup table for a secret shared dataset; and
combining the secret shares of the count lookup tables to generate secret shares of a combined count lookup table for the joint dataset.

3. The method of claim 1, wherein determining the bucket thresholds for each bucket interval comprises:
generating secret shares of a number of datapoints in the joint dataset that are less than an upper bound;
determining a secret share of the upper bound; and
determining a secret share of the upper and lower bounds of each bucket.

4. The method of claim 3, wherein the generating the secret shares of the number of data points in the joint dataset that are less than an upper bound relies on the precomputation such that the communication complexity is independent of the size of the joint dataset.

5. The method of claim 1, wherein assigning data points to the buckets comprises:
performing secure comparisons to determine, for each datapoint, the corresponding bucket.

6. The method of claim 1, wherein the number of buckets is predefined, and neither the private data of the respective other party nor the true values of the bucket intervals is revealed to either party.

7. The method of claim 1, wherein the output is used to perform one or more of i) statistical analysis or ii) machine learning training and inference on secret shared values.

8. A system comprising:
one or more computers and one or more storage devices on which are stored instructions that are operable, when executed by the one or more computers, to cause the one or more computers to perform operations comprising:
for a first party and a second party, performing secure quantile bucketing on a joint dataset comprising first data of the first party and second data of the second party, the performing comprising:
precomputing a secret shared count lookup table for the joint dataset;
determining secret shares of bucket thresholds for each bucket interval;
assigning data points to the buckets based on the secret shared bucket thresholds; and
providing the first party and the second party with an output comprising a list of bucket thresholds in secret shared form and an label per data point in secret shared form identifying the bucket assigned to each data point.

9. The system of claim 8, wherein precomputing the count lookup table for the joint dataset comprises:
generating secret shares of a first count lookup table for the first data and a second count lookup table for the second data;
generating secret shares of a count lookup table for a secret shared dataset; and
combining the secret shares of the count lookup tables to generate secret shares of a combined count lookup table for the joint dataset.

10. The system of claim 8, wherein determining the bucket thresholds for each bucket interval comprises:
generating secret shares of a number of datapoints in the joint dataset that are less than an upper bound;
determining a secret share of the upper bound; and
determining a secret share of the upper and lower bounds of each bucket.

11. The system of claim 10, wherein the generating the secret shares of the number of data points in the joint dataset that are less than an upper bound relies on the precomputation such that the communication complexity is independent of the size of the joint dataset.

12. The system of claim 8, wherein assigning data points to the buckets comprises:
performing secure comparisons to determine, for each datapoint, the corresponding bucket.

13. The system of claim 8, wherein the number of buckets is predefined, and neither the private data of the respective other party nor the true values of the bucket intervals is revealed to either party.

14. The system of claim 8, wherein the output is used to perform one or more of i) statistical analysis or ii) machine learning training and inference on secret shared values.

15. One or more computer-readable storage media encoded with instructions that, when executed by one or more computers, cause the one or more computers to perform operations comprising:
for a first party and a second party, performing secure quantile bucketing on a joint dataset comprising first data of the first party and second data of the second party, the performing comprising:
precomputing a secret shared count lookup table for the joint dataset;
determining secret shares of bucket thresholds for each bucket interval;
assigning data points to the buckets based on the secret shared bucket thresholds; and
providing the first party and the second party with an output comprising a list of bucket thresholds in secret shared form and an label per data point in secret shared form identifying the bucket assigned to each data point.

16. The computer-readable storage media of claim 15, wherein precomputing the count lookup table for the joint dataset comprises:
generating secret shares of a first count lookup table for the first data and a second count lookup table for the second data;
generating secret shares of a count lookup table for a secret shared dataset; and
combining the secret shares of the count lookup tables to generate secret shares of a combined count lookup table for the joint dataset.

17. The computer-readable storage media of claim 15, wherein determining the bucket thresholds for each bucket interval comprises:
generating secret shares of a number of datapoints in the joint dataset that are less than an upper bound;
determining a secret share of the upper bound; and
determining a secret share of the upper and lower bounds of each bucket.

18. The computer-readable storage media of claim 17, wherein the generating the secret shares of the number of data points in the joint dataset that are less than an upper bound relies on the precomputation such that the communication complexity is independent of the size of the joint dataset.

19. The computer-readable storage media of claim 15, wherein assigning data points to the buckets comprises:
performing secure comparisons to determine, for each datapoint, the corresponding bucket.

20. The computer-readable storage media of claim 15, wherein the number of buckets is predefined, and neither the private data of the respective other party nor the true values of the bucket intervals is revealed to either party.
